(19) United States
(12) Patent Application Publication
(10) Pub. No.: US 2026/0346548 A1
(43) Pub. Date: Nov. 5, 2026

(54) MULTICOMPONENT COMPOSITE ARTICLE

(71) Applicant: Interfacial Consultants LLC, Prescott, WI (US)

(72) Inventors: Jeffrey J. Cernohous, Hudson, WI (US); Benjamin C. Mac Murray, Minneapolis, MN (US); Jonathan Farren, River Falls, WI (US)

(21) Appl. No.: 19/100,202

(22) PCT Filed: Aug. 10, 2023
(86) PCT No.: PCT/US2023/029975

§ 371 Date: Jan. 31, 2025

Related U.S. Application Data
(60) Provisional application No. 63/396,648, filed on Aug. 10, 2022.

(51) Int. Cl. B29C 64/40; B29C 64/118; B29K 67/00; B29L 31/00; B33Y 10/00; B33Y 40/20; B33Y 80/00

(52) U.S. Cl. CPC B29C 64/40; B29C 64/118; B33Y 10/00; B33Y 40/20; B33Y 80/00; B29K 2067/046; B29L 2031/757

(57) ABSTRACT

Compositions and methods for the production of multicomponent composite articles using three dimensionally printed sacrificial tooling is provided. In one embodiment, a multicomponent composite article comprising; 1) three dimensionally printing a sacrificial tool from a soluble material, 2) three dimensionally printing one or more additional materials to create a secondary structure, 3) adding a free-flowing material into the sacrificial tool and contacting the secondary structure, 4) curing the liquid material to a solid state, and 5) dissolving the sacrificial tool with a solvent is described. In another embodiment, the secondary structure is orthogonally soluble and provides a voided composite article once orthogonally removed. Articles of this invention have utility in a wide range of industries, including automotive components, jigs and fixtures, tooling, and aerospace components.

### CROSS-REFERENCE TO RELATED APPLICATION

This application claims priority to U.S. Provisional Application No. 63/396,648 filed Aug. 10, 2022, which is hereby incorporated by reference.

### FIELD OF THE INVENTION

This invention generally relates to a method and tool to produce complex, composite materials.

### BACKGROUND OF THE INVENTION

A primary benefit of Additive Manufacturing (AM) processes, commonly referred to as three-dimensional (3D) printing, is their ability to produce complex shapes that would be either very difficult or prohibitively costly to produce through other forming methods such as injection molding, thermoforming, or milling. Though this makes AM attractive for manufacturing complex shapes, not all materials can be easily 3D printed. For example, a 2-part liquid polyurethane is not as easily deposited and rapidly solidified at the same timescale and resolution as thermoplastic polylactic acid (PLA). For this reason, it is often advantageous to use easily 3D printed materials as tooling or molds, that are subsequently used to form materials that are not easily printed. This method can provide the benefits of both a complex part shape and excellent, functional material properties in the final part while also being a time- and cost-efficient process. For example, considering casting a 2-part polyurethane material, a mold printed from a Fused Filament Fabrication (FFF) printer can produce parts nearly identical to those from a machined aluminum mold, while also being significantly less expensive and faster to produce.

Another benefit of AM processes is the geometric freedom afforded by layer-by-layer fabrication. One way that “complex design” is routinely applied is the use of space-filling infill patterns used in FFF printing. Often hidden from view behind solid exterior walls, these infill patterns provide structure to FFF parts and can greatly impact extrinsic part properties such as density and rigidity. Though some of these infill patterns could be fabricated or machined through non-AM processes, they would require substantial additional design or manufacturing time and create additional waste material. Conversely, with FFF printing, these infill patterns provide a savings in both print time and material use and are often rapidly, automatically generated by software.

When soluble 3D-printed tools are used, additional benefits arise. Because the soluble tool is sacrificial, a complex multi-part mold design can become a single-part mold. Additionally, pickouts and parting lines are eliminated when using a single-part mold which create a cleaner molded part.

FFF-printed, water soluble molds can enable complex geometries to be formed that cannot be made via simple two-part molds. However, the limitations of this concept are two-fold: 1) molds that have significant overhangs cannot be produced and 2) the cast part will be largely isotropic. The limitation of no overhanging features greatly reduces the possible number of shapes that can be formed using this method.

In addition to serving as interior structures, infill patterns also often serve as exterior support structures in AM. Support structures are not necessary for every printed shape but they are essential for any printed shape containing overhanging features. In an FFF print without support structures, as each new layer of material is deposited in space, any overhanging features can be difficult to print as there is no substrate to support the material being deposited. When implemented, support structures serve as that substrate, allowing overhanging features to be printed cleanly.

Multi-material AM can be used to create reinforced cylindrical composites with beneficial anisotropy. These composites can be produced by 3D printing a 3-layer construction with two materials where the middle layer is designed reinforcement. This method requires both materials of the final composite to be 3D printable and a mandrel substrate to print upon, which inherently limits the attainable 3D shapes.

The invention provides such a method to produce composites using sacrificial tooling. These and other advantages of the invention, as well as additional inventive features, will be apparent from the description of the invention provided herein.

### BRIEF SUMMARY OF THE INVENTION

In one aspect, the disclosure provides a method of producing multicomponent composite materials using both sacrificial tooling and an embedded secondary structure. The design and composition of the secondary structure can impart unique material properties into the composite.

In another aspect, the disclosure provides a method for producing a multicomponent composite article comprising the steps of 1) three dimensionally printing a sacrificial tool from a soluble material, 2) three dimensionally printing one or more additional materials to create a secondary structure, 3) adding a free-flowing material into the sacrificial tool and contacting the secondary structure, 4) curing the liquid material to a solid state, and 5) dissolving the sacrificial tool with a solvent.

In yet another aspect, the disclosure provides a method of producing an article comprising the steps of 1) three dimensionally printing a sacrificial tool from a soluble material, 2) three dimensionally printing one or more additional materials to create a secondary structure that serves as a support structure for the sacrificial tool, 3) dissolving the secondary structure with a solvent, 4) adding a free flowing material into the sacrificial tool and contacting the secondary structure, 4) curing the liquid material to a solid state, and 5) dissolving the sacrificial tool with a solvent.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a three dimensional model illustrating various secondary structures;

FIG. 2 is a three dimensionally printed AQ120 and PLA mold for producing a PDMS/PLA composite that demonstrates different rigidity in different x, y, and z directions;

FIG. 3 is a three dimensionally printed AQ120 and black PLA mold for producing a reinforced composite illustrating different rigidity in the reinforced and non-reinforced portions;

FIG. 4 is a three dimensionally printed AQ120 mold for producing a porous article; and

FIG. 5 is a three dimensionally printed AQ120 mold for producing a partially porous article containing hollow gyroid-shaped voided space.

While the invention will be described in connection with certain embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Unless the context indicates otherwise the following terms shall have the following meaning and shall be applicable to the singular and plural:

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The terms “additive manufacturing”, “three-dimensional printing”, “3D printing,” or “3D printed” refer to any process used to create a three-dimensional object in which successive layers of material are formed under computer control (e.g., electron beam melting (EBM), fused filament fabrication (FFF), material jetting, laminated object manufacturing (LOM), selective laser sintering (SLS), and stereolithography (SL)).

The term “back-filling” refers to the process of pouring or injecting a second free-flowing material into the voids of the cured first free-flowing material.

The term “curing” means a process of converting a free-flowing material to a solid material by a chemical reaction or by applying or removing an external source of energy (e.g., heat, moisture, electricity, sound, actinic radiation).

The term “dissolution” means a process of dissolving a material (e.g., a sacrificial tool) with a solvent.

The term “free-flowing material” means a material in a free-flowing state that can be utilized to fill a sacrificial tool and encapsulate a secondary structure. The free-flowing material solidifies once cured and does not dissolve upon removal/dissolution of the sacrificial tool, yielding a multicomponent composite article.

The term “infill” means a software-generated, space-filling structure that fills the interior volume of a shape to be printed. Infills often contain void space and can take the form of many different types of structures.

The term “multicomponent composite article” means a material that has at least one additional material within it that was three dimensionally printed.

The term “orthogonal solubility” describes a two material pairing where each material is soluble in one solvent system and is also insoluble in the solvent system of the paired material.

The term “sacrificial tool” means a three dimensionally printed structure with hollow cavities that can be filled with a liquid material and dissolved after curing of the liquid material to a solid state.

The term “secondary structure” means a three dimensionally printed structure that is concurrently printed and/or placed into contact with the sacrificial tool. The secondary structure is in contact with and/or encapsulated by a liquid material to create a three-dimensional structure that does not dissolve upon removal/dissolution of the sacrificial tool.

The term “slicing software” refers to software used to digitally convert a 3D digital file (often an .stl filetype) into instructions readable by a 3D printer (often a .gcode filetype).

The terms “support material”, or “support structure” refer to a material that is printed in three dimensions using an additive manufacturing process to physically support or brace the printed part during 3D printing and that can be removed after the additive manufacturing process

The term “voided composite article” means the composite that results from removal of the secondary structure from the multicomponent composite article (whether removed physically or by dissolution, chemical degradation or exposure to energy/actinic radiation).

The recitation of numerical ranges using endpoints includes all numbers subsumed within that range (e.g., 1 to 5 includes 1, 1.5, 3, 3.95, 4.2, 5, etc.).

This disclosure defines a method to combine both printed sacrificial tooling and designed infill patterns to produce unique composites with embedded reinforcement. A process for the production of a multicomponent composite article comprising; 1) three dimensionally printing a sacrificial tool from a soluble material, 2) three dimensionally printing one or more additional materials to create a secondary structure, 3) adding a free flowing material into the sacrificial tool and contacting the secondary structure, 4) curing the liquid material to a solid state, and 5) dissolving the sacrificial tool with a solvent.

The tool may take the form of a mold and may include common mold features such as pouring basins, sprues, runners, and gates. Any 3D printing method useful for printing thermoplastic materials can be utilized to print the sacrificial tool. Non-limiting examples of 3D printing methods including fused filament fabrication (FFF), selective laser sintering (SLS), selective toner electrophotographic deposition (STEP) and powder bed fusion.

The sacrificial tool may be made from any 3D-printable, soluble material. Materials that are water-soluble can be used due to their ease of use and the nonhazardous nature of water. Non-limiting examples of water soluble materials useful in this invention include polymers and copolymers of polyalkylene glycols, polyalkylene oxides, sulfopolyester salts, polyoxazolines, polyvinylpyrrolidinones and polyvinyl alcohols. Aside from water-soluble materials, materials that dissolve or degrade in acidic solutions, basic solutions, or solvents may also form the sacrificial tool. Non-limiting examples of materials that can dissolve or degrade in acidic or basic solutions useful in this invention include polymers and copolymers of polyacrylic acid, polymethacrylic acid, polyalkyl acrylates and methacylates, polyesters, polyethers and polycarbonates. polyalkylacrylics, Non-limiting examples of materials that can dissolve or degrade in solvents useful in this invention include polymers and copolymers of polyacrylates, polymethacrylates, polystryenics, polycarbonates, polyesters, polyethers, polysiloxanes, polyacrylonitrile-styrene-butadiene copolymers, polyolefins and polyamides. So long as a material dissolves, degrades, swells, or weakens sufficiently to be removed from the multicomponent composite article, it may be used to form the sacrificial tool.

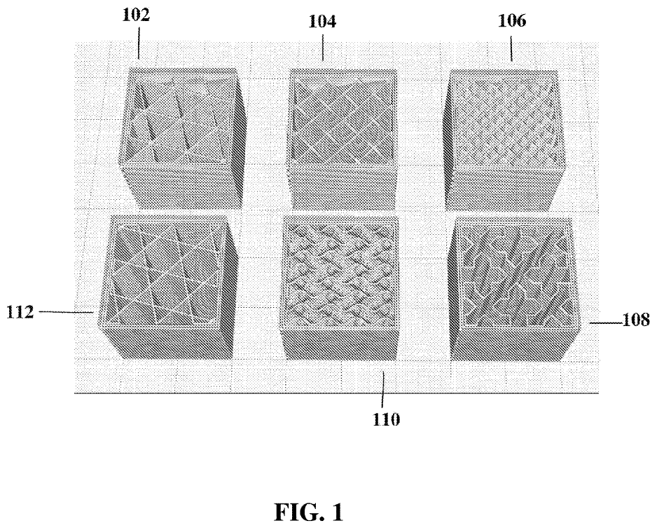

The secondary structure may take a variety of forms and be composed of a variety of materials. A simple way to generate the secondary structure form is by adjusting “Infill” settings in the Cura software. The secondary structure may take the form of Grid, Lines, Triangle, Tri-Hexagon, Cubic, Cubic Subdivision, Octet, Quarter Cubic, Concentric, Zig Zag, Cross, Cross 3D, Gyroid, or Lightning infill patterns that are all available through Cura, or can take the form of a custom, manually designed structure. FIG. 1 illustrates various secondary structures. 102 illustrates a secondary structure in the form of Triangles. 104 illustrates a secondary structure in the form of Grid. 106 illustrates a secondary structure in the form of Lines. 108 illustrates a secondary structure in the form of Cross. 110 illustrates a secondary structure in the form of Gyroid. 112 illustrates a secondary structure in the form of Tri-Hexagon. Each structure will have distinct advantages and disadvantages as reinforcement and one may be preferable to another depending on the intended function of the final composite. The secondary structure can also be generated to different volume-filling extents. For example, a 20% infill density will form a more sparse structure than an 80% infill density, therefore the material properties of the secondary structure will dominate the composite properties to a greater degree with 80% infill compared to 20%.

The secondary structure may be any variety of insoluble polymeric materials, including, but not limited to, polymers, copolymers and blends of polyesters, polyolefins, polyamides, polycarbonates, polyarylethers, polyethers, polyacrylates, polymethacrylates. While the secondary structure can be a material that does not swell, weaken, or otherwise change when exposed to water, it is possible to use certain hydrophylic materials (such as polyesters and polyamides) as the secondary structure.

In some embodiments, the secondary structure is an orthogonally soluble material, meaning that it will dissolve or degrade in a solvent, acid or basic solution that does not dissolve the primary soluble tool. In such embodiments, the first soluble material can be a water soluble polymer and the orthogonally soluble material dissolves in a solvent. For example, Aquasys General Purpose is a suitable water soluble polymer and high impact polystyrene (HIPS) is a suitable orthogonally soluble polymer. Aquasys General Purpose is soluble in water but is insoluble in limonene. Conversely, HIPS is soluble in limonene, but not in water. As another example, Aquasys General Purpose and Acrylonitrile-Butadiene-Styrene (ABS) could be used as orthogonally soluble polymers. ABS dissolves readily in acetone but not in water. Aquasys General Purpose does not dissolve in acetone. The pairing of two orthogonally soluble materials enables selective dissolution and allows for one material to be dissolved before the other.

The free-flowing material may be a variety of materials including, but not limited to, thermoplastic polymers, precursor mixtures of thermosetting polymers, thermoplastic powders, metals, and others. In embodiments using meltable thermoplastic, metals, or powders, a requirement of these materials is that the melting point be sufficiently low so as not to deform or degrade the sacrificial tool and secondary structure. Non-limiting examples of thermosetting polymers include epoxies, polysiloxanes, polyurethanes and polyesters. Non-limiting examples of thermoplastic polymers and powders include polyolefins, polyamides, polyesters, thermoplastic elastomers, polycarbonates, fluoropolymers, polyarylethers, and polyethers. Non-limiting examples of metal powders include titanium, aluminum, stainless steel, copper, silver, and gold. In some embodiments, a low-viscosity, liquid free-flowing material can be used to attain rapid and complete filling of the sacrificial tool. In other embodiments, a free-flowing material can be selected due to its ability to be unaffected by the solvent and dissolution process.

A variety of fillers can be added with the free-flowing material into the sacrificial tool. In view of this disclosure, one or more fillers can be selected to improve mechanical and thermal properties for desired applications, including, e.g., reducing the coefficient of thermal expansion of a let-down product. Non-limiting examples of fillers include mineral and organic fillers including carbonates, silicates, talc, mica, wollastonite, clay, silica, alumina, carbon fiber, carbon black, carbon nanotubes, graphite, graphene, volcanic ash, expanded volcanic ash, perlite, glass fiber, solid glass microspheres, hollow glass microspheres, cenospheres, ceramics, and conventional cellulosic materials including: wood flour, wood fibers, sawdust, wood shavings, newsprint, paper, flax, hemp, wheat straw, rice hulls, kenaf, jute, sisal, peanut shells, soy hulls, or any cellulose containing material.

In some embodiments, filler used in conjunction with the free-flowing material may include one or more lightweight fillers. Non-limiting examples of lightweight fillers include hollow glass microspheres, cenospheres, perlite, and expanded volcanic ash.

The free-flowing material may be added to the sacrificial tool via pouring or injection. In some embodiments the free-flowing material has sufficiently low viscosity that it will fill the sacrificial tool cavity readily. In other embodiments, pressurized injection is necessary to fill the tool with the free-flowing material within the timeframe before curing begins.

In some embodiments, the secondary structure will be present when the free-flowing material is added. In other embodiments, the secondary structure is dissolved or otherwise removed before the free-flowing material is added. In those where the secondary structure is present, the free-flowing material must contact a portion of the secondary structure before it cures. The secondary structure may be a lattice structure that becomes embedded in the final multicomponent composite article. In another embodiment, the secondary structure may be an impermeable shape that prevents the free-flowing material from filling a volume of the sacrificial tool. In some embodiments, the free-flowing material may only contact a portion of the secondary structure, for example if multiple free-flowing materials will be used to fill the sacrificial tool.

The curing process entails converting a free-flowing material to a solid material. Examples of curing may include, but are not limited to, solidification of materials from a melt state and solidification of a liquid induced by an external stimulus including (heat, moisture, electricity, sound, or actinic radiation). Another example of curing includes mixing a 2-part resin system together and allowing sufficient time for solidification to occur. In some embodiments the curing process may be halted temporarily or permanently prior to the dissolution process. In these cases, sufficient cure is achieved once the free-flowing material will hold its shape when the sacrificial tool is removed.

The dissolution process entails the following steps: submerging the filled sacrificial tool in the solvent, waiting a sufficient duration of time for the solvent to dissolve the tool, removing the cast form from the solvent, and allowing a sufficient duration of time for the solvent to evaporate. Optionally, agitation, solvent refreshing, and heat can be applied during dissolution to speed up the process and vacuum, heat, or a dry environment can be used to speed up solvent evaporation.

The printed, soluble material may be dissolved or degraded in water, acidic solutions, basic solutions or solvents. For example, polyvinyl alcohol (PVOH), AquaSys 120, AquaSys General Purpose are nonlimiting examples of water soluble materials. Polyesters are nonlimiting examples of materials degradable and soluble in acidic and/or basic solutions. Stratasys SR30/SR35 support materials are nonlimiting examples of base soluble materials and High Impact Polystyrene (HIPS) is an nonlimiting example of a solvent soluble material. In some embodiments, the water-soluble materials are used as they avoid the use of hazardous solvents. One such water-soluble material that can be used is Aquasys General Purpose due to its high print quality and rapid dissolution in water.

In some embodiments, the dissolving solvent is water but can include additional solvents such as limonene, acetone, dichloromethane, methanol, ethanol, and acidic and basic aqueous solutions. Dissolving the sacrificial tool in water is relatively nonhazardous compared to other solvents that could be used.

In some embodiments, the secondary structure can be dissolved or removed to yield a voided composite article. The voided composite article may contain hollow pores, channels, planes, or volumes where the secondary structure has been removed. The voids may be interconnected or isolated from each other. Since the voids are formed by removing the secondary structure, there must be a pathway for solvent to reach the secondary structure. As one example, an isolated channel void could be formed provided it has a portion reaching the exterior of the multicomponent composite article.

A process of back-filling may be used once the voided article is formed. A second free-flowing material may be used to entirely or partially fill the voids. After the second free-flowing material has cured, this process forms a multicomponent composite material in which neither of the two materials forming the composite needs to be 3D-printable. In some embodiments, the second free-flowing material is a different material than the first free-flowing material.

Articles of this invention have utility in a wide range of industries, including automotive components, jigs and fixtures, tooling, and aerospace components.

### EXAMPLES

All examples were 3D printed on an Ultimaker S3 Fused Filament Fabrication 3D printer using Cura 4.10.0 as the slicing software. Examples 1 and 2 used Aquasys 120 (Infinite Materials Solutions, Prescott, WI, USA) as the water-soluble filament and Tough PLA Black (Ultimaker B.V., Utrecht, Netherlands) as the secondary structure material. Examples 5 and 6 used only Aquasys 120 filament. All filament was 2.85 mm in diameter, which is standard for Ultimaker printers. Tough PLA Black was printed using an AA print core and Aquasys 120 was printed using a BB print core, as recommended by the material manufacturers.

Each example was printed with the default, recommended print profile settings for each material, including the few representative settings listed below:

| Print setting | Tough PLA Black | Aquasys 120 |
|---|---|---|
| Layer Height [mm] | 0.2 | 0.2 |
| Printing Temperature [°C] | 215 | 240 |
| Bed Temperature [°C] | 100 | 100 |
| Print speed [mm/s] | 50 | 30 |
| Line width [mm] | 0.35 | 0.35 |
| Wall line count | 0 | 3 |

Examples 1, 2, 5, and 6 consisted of cube-shaped molds where each edge was 20 mm long. In Cura, these were set up as 2 separate identical cubes that were arranged to entirely overlap. One cube was used to create the mold walls and the other to create the secondary structure (infill). All molds were made with the following settings:

| Print Setting | |
|---|---|
| Mold | checked |
| Minimal Mold Width [mm] | 2 |
| Mold Roof Height [mm] | 0.5 |
| Mold Angle [°] | 40 |

The molds were designed to have solid bottom and side walls but no top, to allow for easy casting of the free-flowing material.

The free-flowing material was EcoFlex 00-30 2-part silicone (Smooth-On, Macungie, PA, USA). Prior to casting, EcoFlex 00-30 parts A and B were combined in the directed 1:1 mass ratio and mixed vigorously by hand stirring for about 1 min. The mixture was then placed in a vacuum oven under full vacuum for about 5 minutes to remove entrapped air bubbles. After degassing, the silicone was poured into the cube mold slowly to avoid creating new air bubbles. The molds were then left at room temperature for 24 hrs to allow the silicone to cure. After this, the parts and mold were placed in a glass jar filled with tap water, which was then placed in an oven at 80 °C for 24 hours to allow the Aquasys 120 to dissolve. When the Aquasys 120 was fully dissolved, the parts were removed from the jar, rinsed for 1 minute in tap water to remove any residual material on the surface, and placed in the oven at 80 °C for about 16 hours to dry.

### Example 1: Reinforced Composite with Designed Anisotropy

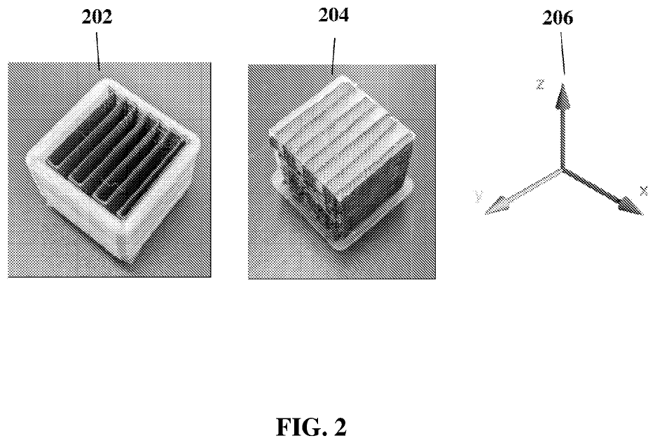

This demonstrates anisotropic mechanical properties imparted by the embedded secondary structure. This infill structure was generated in Cura using the Zig Zag infill pattern, 15% infill density, and an infill line direction of “[1]”. The Tough PLA Black printed structure has solid walls in the Y- and Z-directions, contributing to the rigidity of the structure in these directions. In the X-direction, however, the mechanical properties are dominated by the soft, flexible silicone (and the ability of the PLA struts to bend), generating much more compliant behavior. FIG. 2 illustrates an AQ120 and black PLA mold 202, which can be used to produce a PDMS/PLA composite 204 that demonstrates different rigidity in different x, y, z directions 206.

### Example 2: Partially Reinforced Composite

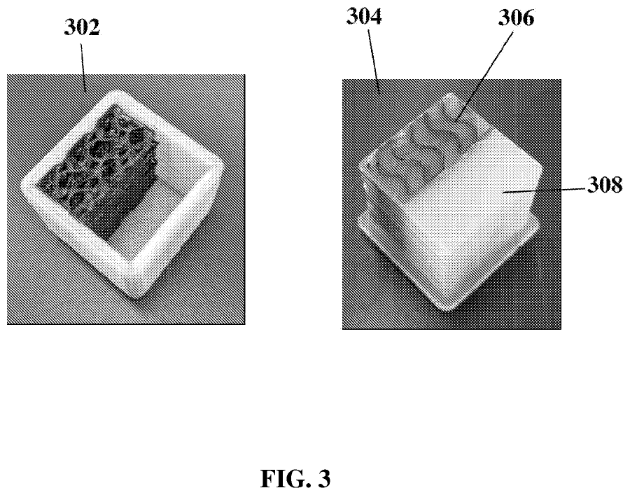

This example demonstrates localized control of mechanical properties through the spatial placement of the secondary structure. Tough PLA Black was printed as a gyroid structure (15% infill density) which provides both an open structure for silicone infiltration and relatively uniform mechanical rigidity in the x, y, and z directions from the gyroid structure. The rigid gyroid structure was localized to only half of the cube volume, resulting in a rigid reinforced region and also a very compliant, unreinforced silicone region. FIG. 3 illustrates an AQ120 and black PLA mold 302, which can be used to produce a PDMS/PLA partially reinforced composite 304 that demonstrates different rigidity in the reinforced portion 306 and the non-reinforced portion 308.

### Example 3: “2 Shot” Material from Staged Dissolution

A sacrificial tool could be produced from a first soluble material and a secondary structure from a second, orthogonally soluble material. A potential material pairing is Aquasys 120 (AQ120; water-soluble, insoluble in limonene) and High Impact Polystyrene (HIPS; limonene-soluble, insoluble in water). The tool was printed in AQ120 and the secondary structure in HIPS. The tool was filled with a free-flowing material and allow it to solidify. Next, the HIPS portion was dissolved with limonene to create a hollowed portion within the cast material which could be backfilled with a second free-flowing material. Once the second material has solidified, the tool was dissolved in water leaving the finished “2 shot” part.

### Example 4: Reinforcement Serving as Print Support

In this example, a mold and reinforcement were produced using 2 materials that are orthogonally/separately soluble. The mold weas printed in AQ120 and the reinforcement in HIPS. Many printed shapes have overhanging features that require support in order to be printed. In this example, the HIPS serves as structural support to the AQ120 during printing. After the mold is printed, the support is no longer needed. The HIPS could be dissolved in limonene, leaving the hollow AQ120 mold ready to be filled with a castable material.

### Example 5: Material with Isolated Hollow Channels

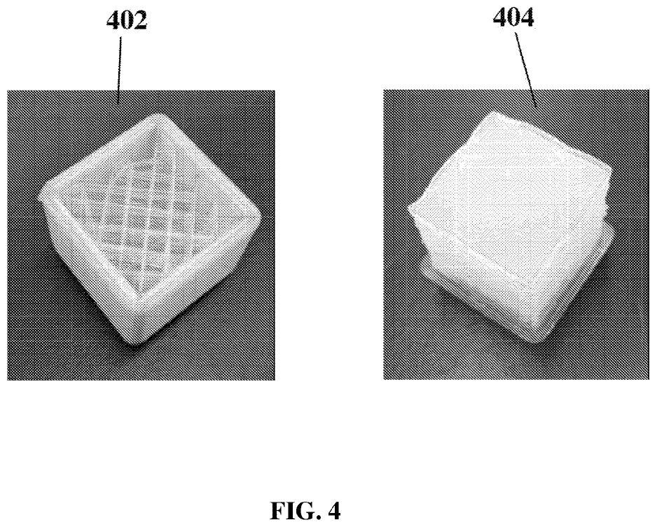

This example demonstrates that hollow channels can be formed from the secondary structure. This example was made using the Lines infill pattern with a density of 15% and an infill layer thickness of 0.4 mm in the Cura slicing software. These settings created the sparse network of single print lines shown below. Each line of the infill was isolated from all others. After casting and dissolution, these printed lines created hollow channels passing through the silicone cube. FIG. 4 illustrates an AQ120 402, which can be used to produce a porous silicone block 404 containing hollow, non-intersecting channels.

### Example 6: Material with Partial Gyroid-shaped Porosity

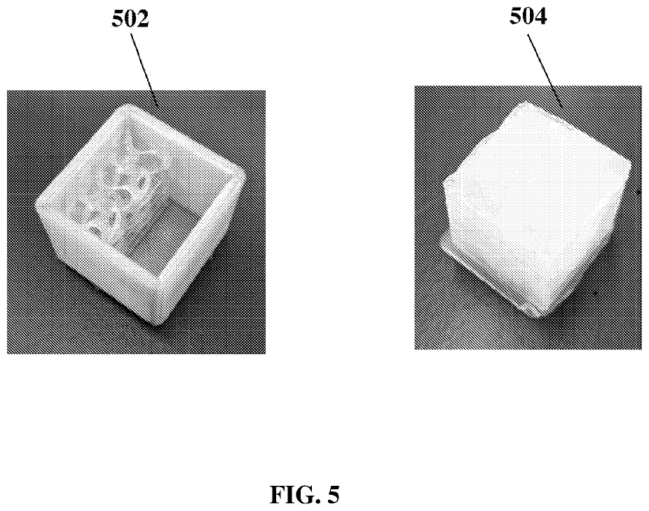

FIG. 5 demonstrates localized control of properties by forming localized voided spaced. FIG. 5 depicts an AQ120 mold 502, which can be used to produce a partially porous PDMS block containing hollow gyroid-shaped voided space.

### Example 7: Material with Graded Porosity

In this example, a mold and reinforcement were both printed from AQ120. The reinforcement dimensions would vary within the mold cavity to be more dense in certain areas and less dense in others. The mold was filled with a castable material and allow it to solidify. Then the mold and reinforcement were dissolved away, leaving a part containing graded or variable porosity where the reinforcement was.

Having thus described particular embodiments, those of skill in the art will readily appreciate that the teachings found herein may be applied to yet other embodiments within the scope of the claims hereto attached.

What is claimed is:

1. A method of producing a multicomponent composite article comprising the steps of:
three dimensionally printing a sacrificial tool from a soluble material;
three dimensionally printing one or more additional materials to create a secondary structure;
adding a free-flowing material into the sacrificial tool and contacting the secondary structure;
curing the liquid material to a solid state; and
dissolving the sacrificial tool with a solvent.

2. The method of claim 1, further comprising the step of dissolving or removing the secondary structure to yield a voided composite article.

3. The method of claim 2, further comprising the step of back-filling the voids of the multicomponent composite article with a second free-flowing material.

4. The method of claim 1, wherein the sacrificial tool is three dimensionally printed using Fused Filament Fabrication.

5. The method of claim 1, wherein the free-flowing material includes one or more fillers.

6. A three dimensionally printed sacrificial tool comprising:
at least one soluble material; and
a secondary structure comprising a second material.

7. The three dimensionally printed sacrificial tool of claim 6, wherein the second material is orthogonally soluble.

8. The three dimensionally printed sacrificial tool of claim 6, wherein the soluble material is water soluble.

9. A method of producing an article comprising the steps of:
three dimensionally printing a sacrificial tool from a soluble material;
three dimensionally printing one or more additional materials to create a secondary structure that serves as a support structure for the sacrificial tool;
dissolving the secondary structure with a solvent;
adding a free flowing material into the sacrificial tool and contacting the secondary structure;
curing the liquid material to a solid state; and
dissolving the sacrificial tool with a solvent.
